(19) United States
(12) Patent Application Publication
(10) Pub. No.: US 2006/0055357 A1
(43) Pub. Date: Mar. 16, 2006

(54) Method and device for identification of the parameters of an electro-mechanical system

(76) Inventors: Robertus Mathijs Gerardus Rijs, EINDHOVEN (NL); Erik Willem Gaal, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/523,045

(22) PCT Filed: Aug. 4, 2003
(86) PCT No.: PCT/IB03/03406

§ 371 Date: Feb. 2, 2005

(30) Foreign Application Priority Data
Aug. 7, 2002 (EP) 02078264.5

(51) Int. Cl. G05B 13/00

(52) U.S. Cl. 318/561

(57) ABSTRACT

The present invention relates to a method for identification of the parameters of an electro-mechanical system, in particular an electro-mechanical servo system, comprising a mass actuated by a force. Based on the time response of the system on the application of a constant force, in particular on a block-wave output of the system, the parameters friction, mass and damping of the system are estimated. This allows accurate feedback and feedforward tuning of the controller. Further, control optimisation can be performed by an iterative procedure.

he present invention relates to a method for identification of the parameters of an electro-mechanical system, in particular an electro-mechanical servo system, comprising a mass actuated by a force. Further, the present invention relates to a method for autotuning a controller of an electro-mechanical system and a method for controlling such an electro-mechanical system. Still further, the invention relates to corresponding devices, in particular a device for identification of the parameters of an electro-mechanical system, to an autotuner and to a controller, as well as to an electro-mechanical system itself. Finally, the present invention relates to a computer program for implementing said methods on a computer.

A numerical control unit for controlling the position of a movable part, such as a machine table, in response to input machining information is known from U.S. Pat. No. 5,159,254. The unit employs a servo control loop that can measure the values of the position, velocity, acceleration and motor current for the movable part at predetermined times. Using such measured values and, on the basis of a representative spring mass system model, values of inertia, mass, viscous friction and sliding friction can be calculated and used for automatically optimising the gain and offset parameters applicable to control of the machine.

Usually, parameter identification of an electro-mechanical system and controller tuning are performed by either an expert who needs to perform measurements by using special equipment, which is even impossible for highly integrated digital servo loops, or by a non-expert who performs a trial and error procedure which often does not result in an optimised performance. It is therefore an object of the present invention to provide a method for identification of the parameters of an electro-mechanical system as well as methods for autotuning the controller of such an electro-mechanical system and a method for controlling the system which do not require any tuning expertise and special measurement equipment and which allow system identification and autotuning to be performed within a very short time, i.e. which only require several seconds or minutes so that a user can save a lot of time. Further, corresponding devices, an electro-mechanical systems and a computer program for implementing said methods shall be provided.

The object is achieved by a method for system identification as claimed in claim 1 comprising the steps of:
a) applying a constant force to said electro-mechanical system for a predetermined time period, said force having an amplitude at a sub-friction level,
b) stopping the mass by applying a negative force,
c) iterating steps a) and b) by increasing the amplitude of the constant force applied in step a) in each iteration until the velocity of said mass is monotonously increasing during application of said constant force,
d) estimating mass and friction of the electro-mechanical system from the measured movement of the mass,
e) performing steps a) and b) at least for another two times by ether increasing the amplitude of the constant force applied in step a) wherein the amplitude is increased in each iteration to at most a maximum level at which the electro-mechanical system does not exceed the boundaries of the electro-mechanical system, and
f) estimating mass, friction and damping of the electro-mechanical system from the measured movement of the mass.

The invention is based on the idea to obtain a smooth movement of the electro-mechanical system as response to the application of a force to the electro-mechanical system during which the system remains in the allowable moving range. The smooth movement is obtained by setting the amplitude and the time period of the applied force carefully. If the predetermined time period is too short the influence of dynamics and virtual play on the estimators will be significant, virtual play meaning play that is commonly caused by a combination of friction and flexibility with the consequence the the actuator may move and load does not. If the predetermined time period is too long it may be impossible to remain within the allowable moving range or the maximum velocity may be exceeded.

The force amplitude is found by an iterative procedure. Starting at sub-friction level the amplitude is raised in small steps until it is detected that the velocity is monotonously increasing during application of the constant force. At this point initial estimates are generated which are used for predicting the displacements of the subsequent steps.

In the subsequent steps the force amplitude is raised at least for another two times, in particular with x % and 2x %, respectively, wherein x is chosen such that the predicted displacement is smaller than the allowable displacement. The responses to the application of these forces are used for identifying friction, mass and damping.

It shall be noted that the present invention is not limited to translating systems, but can be applied to rotating electro-mechanical systems with equal success. Thus, the term “mass” shall be broadly understood as including an inertia (i.e. a rotational mass), and the term force shall be broadly understood as including a torque. The present invention is mainly applied in electro-mechanical servo systems which are often referred to as double integrator systems, but can also be applied in a velocity control loop (single integrator system) or other electro-mechanical systems.

Preferably, the initial friction is estimated based on the ratio between the time required for acceleration and the time required for stopping the mass. Further, a mass-friction-damping mathematical model of the electromechanical system is used for estimating mass, friction and damping of the system. Therein, friction estimation may consist of two estimates, i.e. one estimate for both directions of movement. Based on the differential equations of a mass-friction-damper system and using e.g. four position measurements during two consecutive movements, i.e. by a total of 8 measurements, all important parameters of the system can be estimated.

In a preferred embodiment the force is applied as a block-wave signal having a constant maximum amplitude in step a), i.e. also in the iterations of step a). An alternative is a trapezoidal signal. Said signal may also have, after the positive force amplitude, a negative force amplitude in order to stop the mass according to step b). Amplitude and time period of the positive and negative part of the signal may be identical, however, can also be different.

The required smooth movement is then obtained by setting the amplitude and the frequency of the block-wave signal carefully. A preferred range for the predetermined time period for application of the constant (positive) force is given in claim 5, i.e. in case of a block-wave signal the block-wave frequency is preferably fixed in a range between 0.1 Hz and 50 Hz, preferably at 2 Hz.

To determine the initial amplitude of the force to be applied in step a) the following further steps are provided in a preferred embodiment:
a0) applying a force having a monotonously increasing amplitude until the mass starts moving and
a1) roughly estimating the friction of the electro-mechanical system and determining the direction of movement of the mass from the measured movement of the mass, which steps are performed prior to step a), in which the initial amplitude of the constant force is set lower, in particular 1 to 25% lower, than the friction estimated in step a1).

Thus, the sub-friction level for the amplitude of the force can be determined Preferably, the force is applied as a ramp signal in step a0).

The estimation of the friction in step f) is completely independent of the damping and mass estimates. Preferably, the movements in step e) are in the same direction. However, if the direction dependency of friction is also preferred to be determined at least four movements are required, two with a positive force amplitude and two with a negative force amplitude as claimed in claim 9.

The object of the invention is further solved by a method for autotuning a controller of an electro-mechanical system, wherein the parameters of said electro-mechanical system are identified by a method as described above, said parameters being used to determine the control parameters of a controller, in particular amplification including its sign, i.e. its polarity, integrator frequency, differentiator frequency and/or low-pass filter settings, so that the electro-mechanical system is operated stable in a low frequency area According to the present invention autotuning can be performed easily without special expertise and measurement equipment within a very short time.

Preferably the controller comprises a feedback control unit and a feedforward control unit. However, the feedforward control unit can also be omitted.

An automatic bandwidth optimisation is proposed in claim 12. Based on the response of the system on a short set-point profile a criterion judges whether increasing the bandwidth was an improvement. Values of the bandwidth and the bandwidth increase are given in claim 14. A criterion for judging whether an increase of the bandwidth has led to an improvement is preferably based on a root-mean-square (RMS) error of the difference between the measured movement and the set-point movement, in particular both during movement and during settling. This RMS error shows a clear minimum allowing to identify the optimum bandwidth.

A method for controlling an electro-mechanical system according to the present invention is defined in claim 15. Therein, the parameters of the electro-mechanical system are identified as described above. These parameters are used to determine the control parameters of the controller such that the electro-mechanical system is operated stable by a method for autotuning as described above.

A device for identification of the parameters of an electro-mechanical system comprising control means, sensor means and processing means is defined in claim 16. An autotuner according to the invention is defined in claim 17. A controller according to the invention is defined in claim 18. An electro-mechanical system according to the invention is defined in claim 19. A computer program for implementing the methods according to the invention is defined in claim 20.

The invention will now be explained in more detail with reference to the drawings in which:

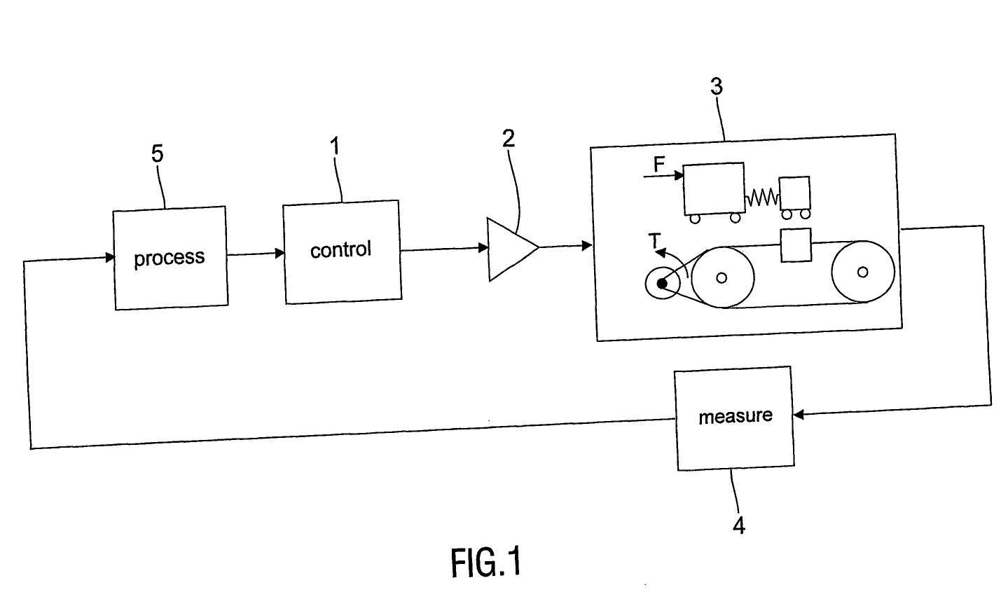

FIG. 1 shows a simple block diagram of a device for identification of the system parameters of an electro-mechanical servo system,

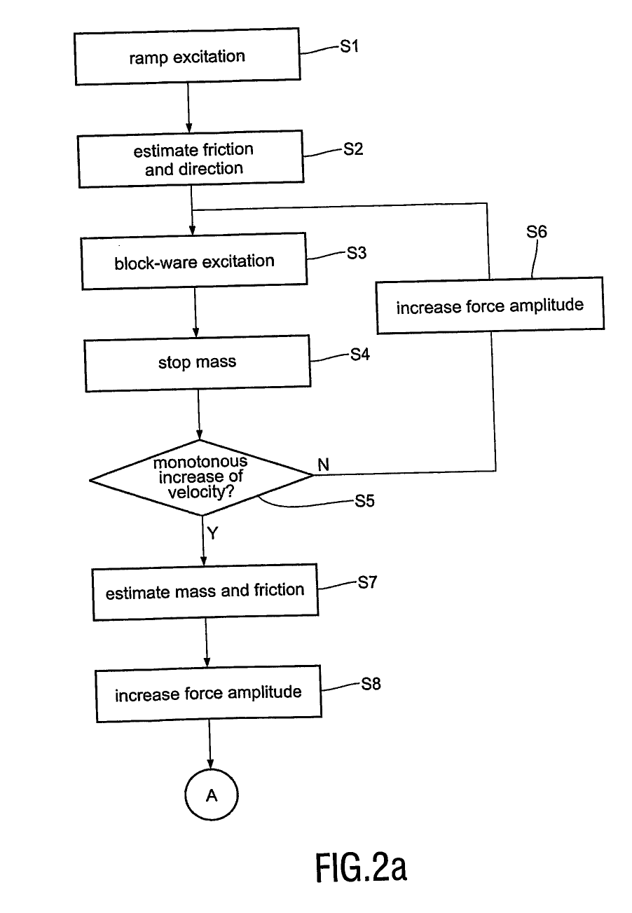

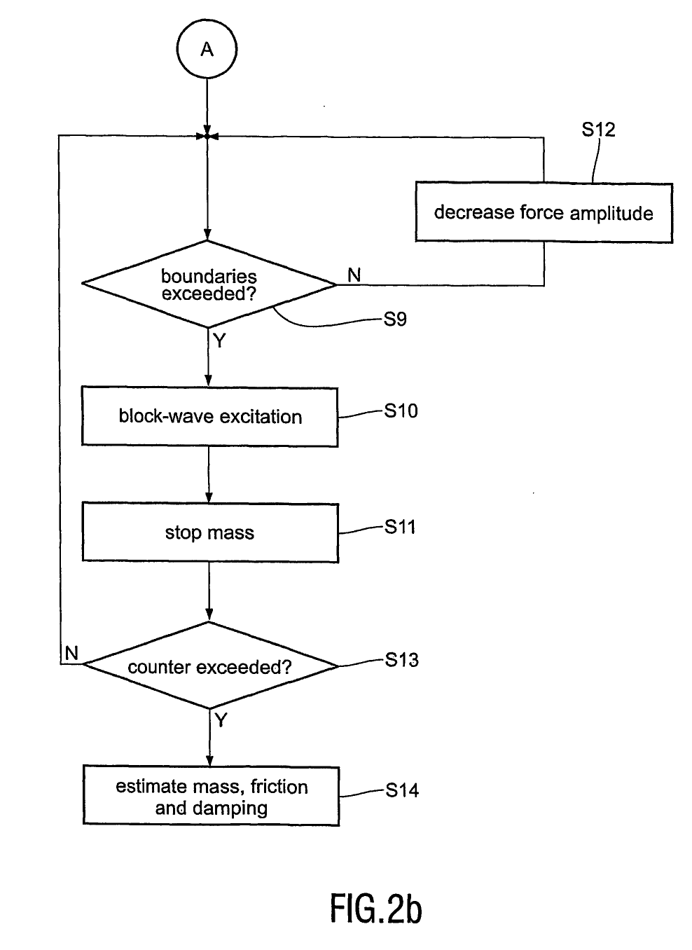

FIG. 2 shows a flow chart of the method for parameter identification according to the invention,

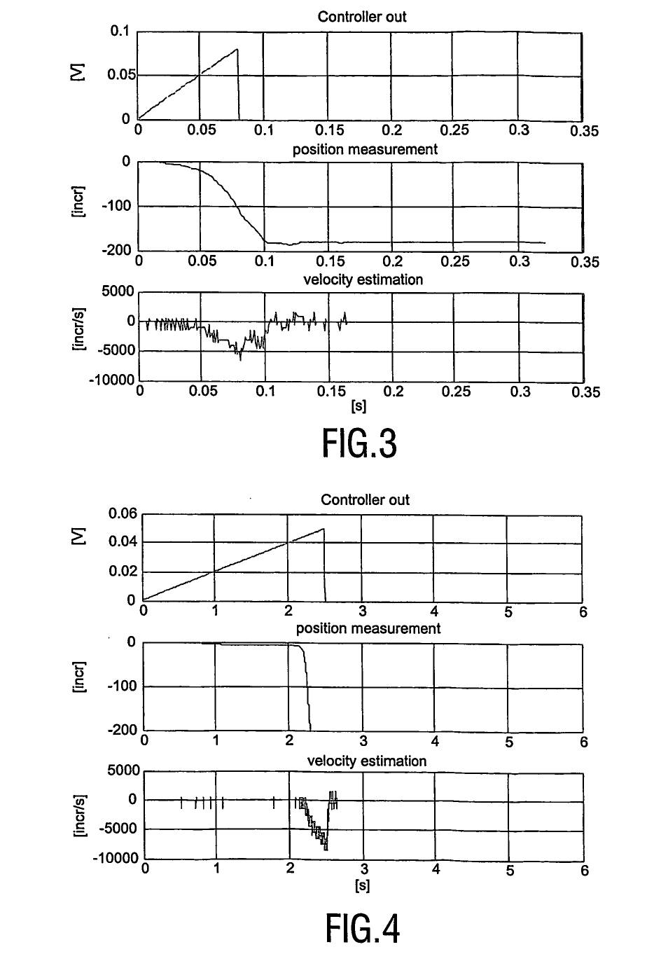

FIGS. 3, 4 show different ramp excitation signals and the measured displacement and velocity,

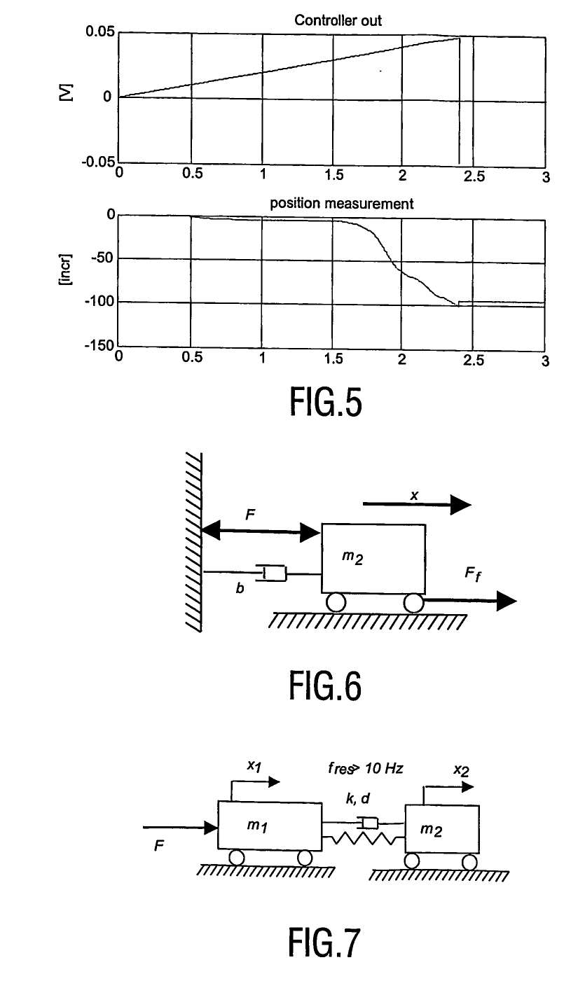

FIG. 5 shows the result of a ramp excitation signal with an experimental set-up,

FIG. 6 shows a mass-friction-damping model,

FIG. 7 shows a general electro-mechanical system,

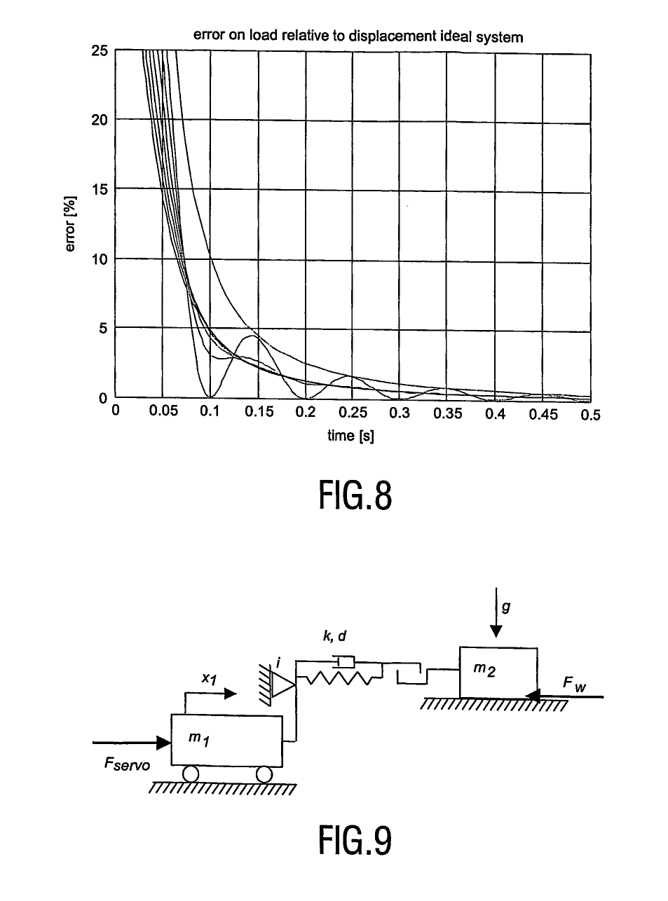

FIG. 8 shows worst-case errors on a load relative to displacement due to dynamics,

FIG. 9 shows a motor controlled fourth order system with friction on the load,

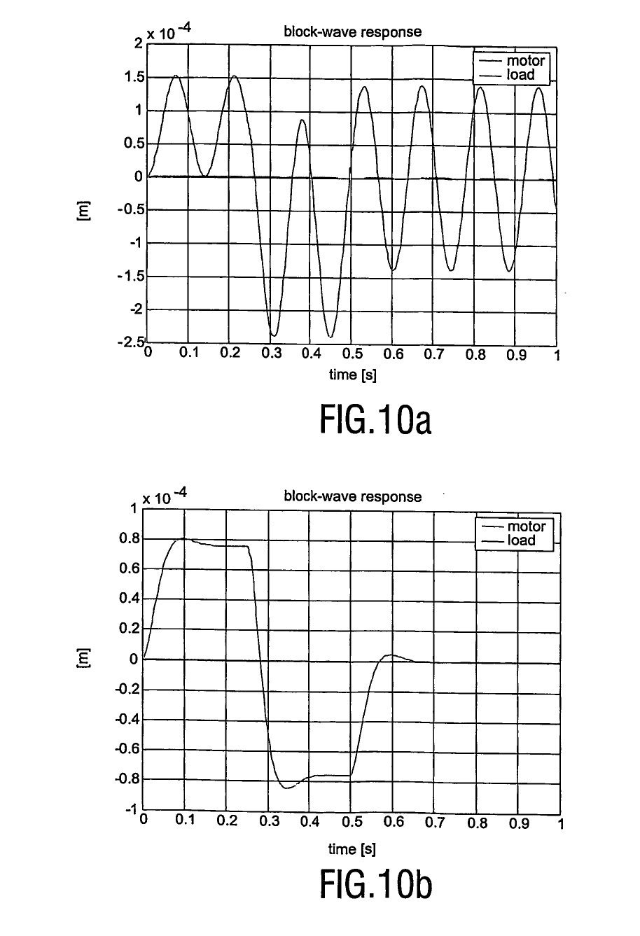

FIG. 10 shows typical block-wave responses of the motor as shown in FIG. 9,

FIG. 11 shows a result of the first block-wave signal,

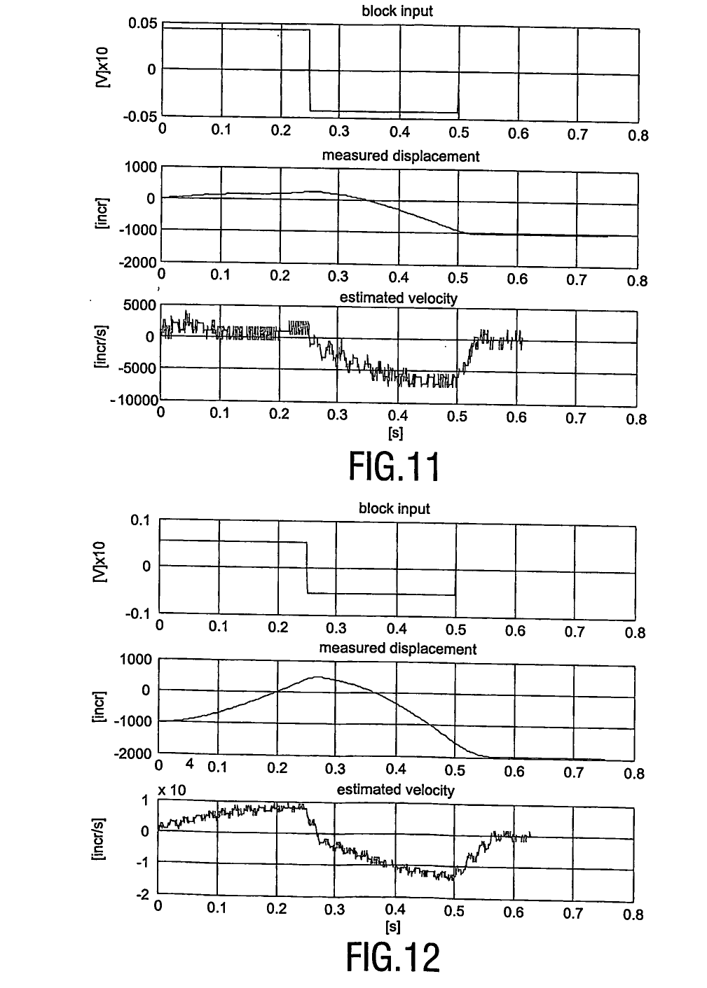

FIGS. 12-14 show the results of a block-wave signal having increased amplitudes,

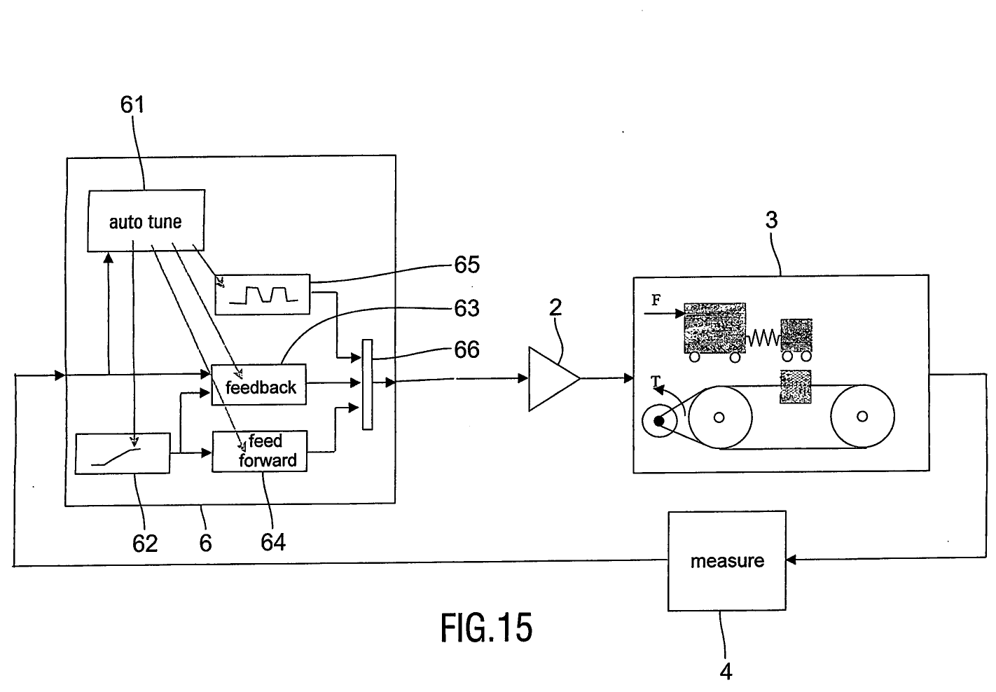

FIG. 15 shows a block diagram of a controller according to the present invention,

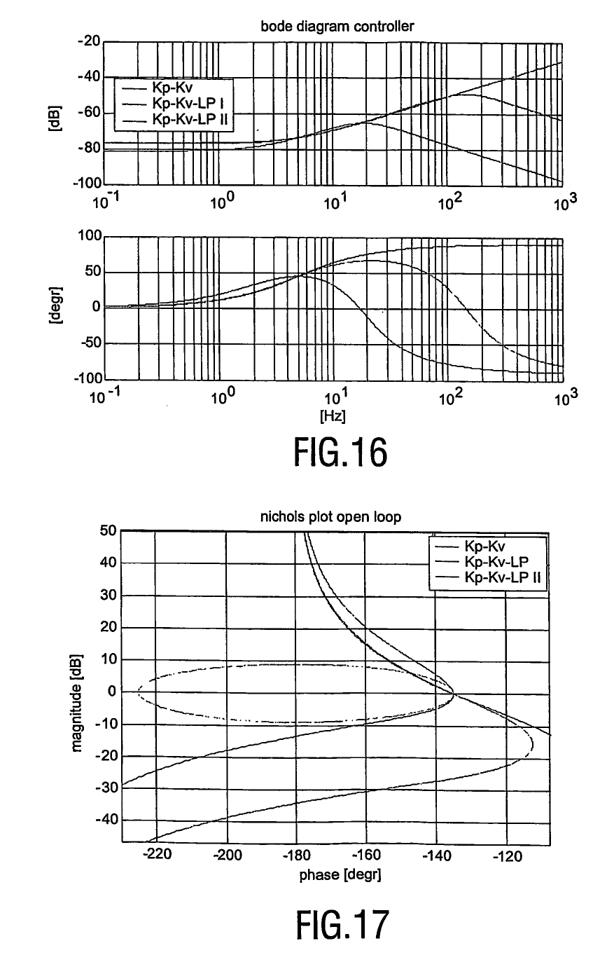

FIG. 16 shows bode diagrams of the controller for various settings of the controller parameters,

FIG. 17 shows Nichols plots of the controllers shown in FIG. 16,

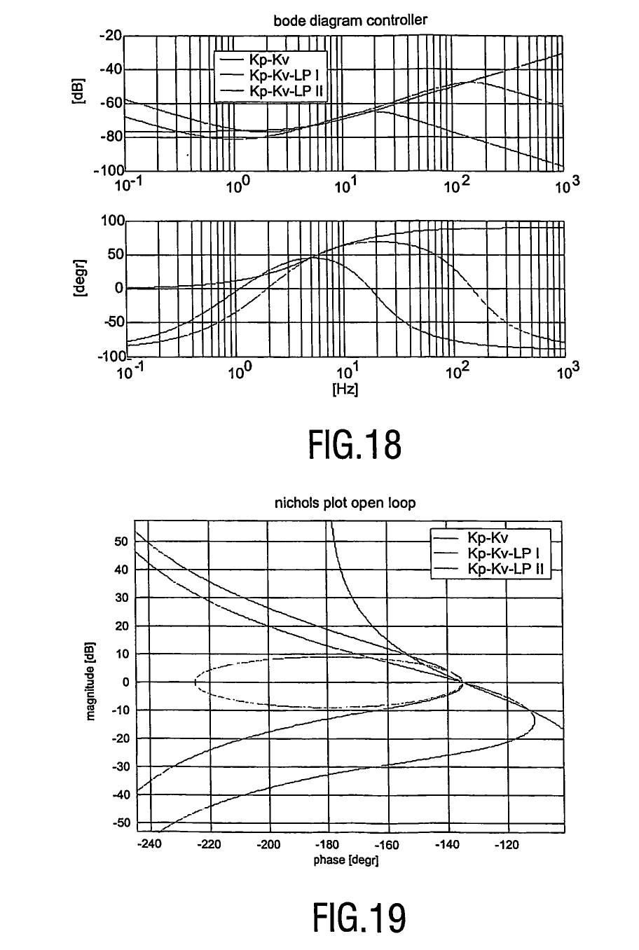

FIG. 18 shows bode diagrams of another controller,

FIG. 19 shows Nichols plots of the controllers shown in FIG. 18,

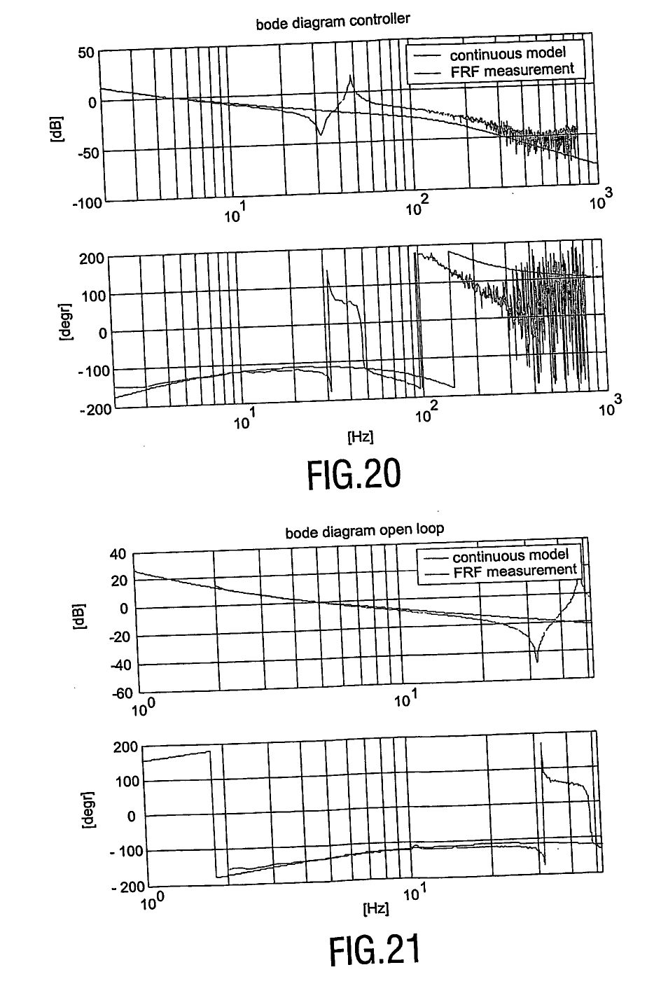

FIG. 20 shows a bode diagram of an open-loop,

FIG. 21 shows abode diagram of an open loop, zoomed on low frequencies,

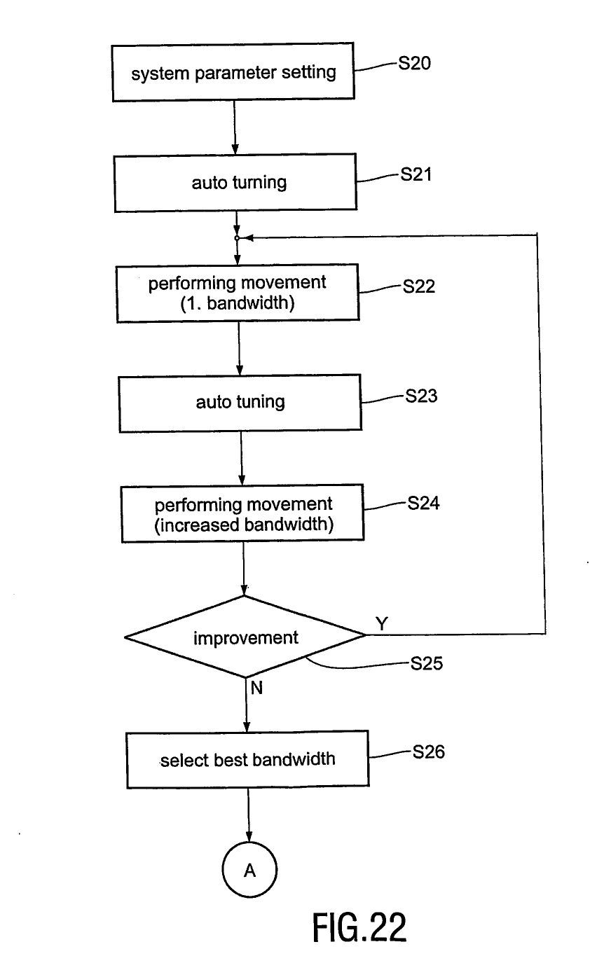

FIG. 22 shows a flow chart of the method for optimising the bandwidth of the controller,

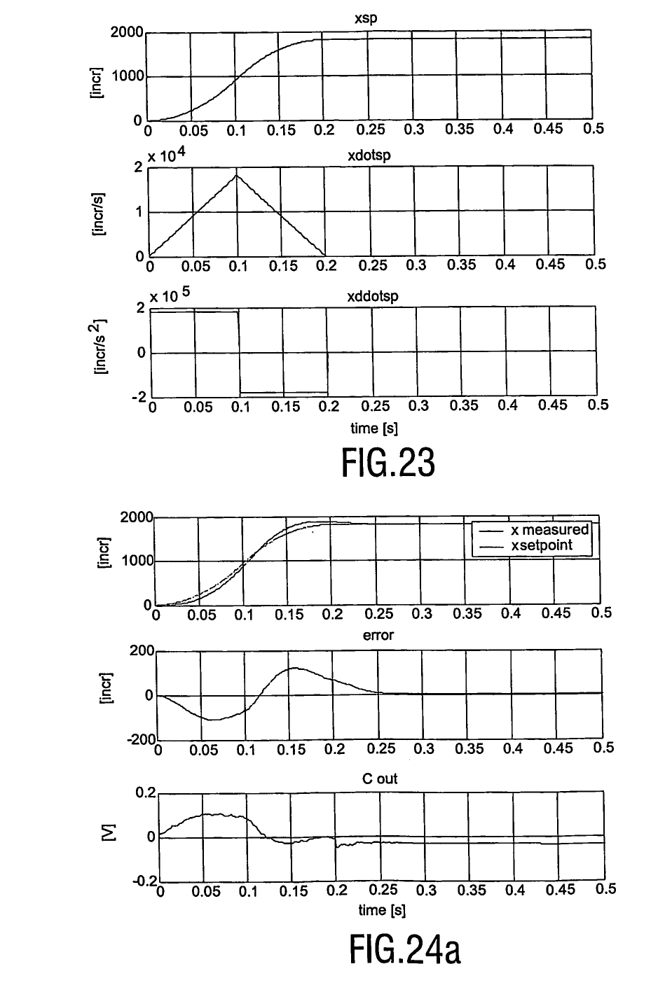

FIG. 23 illustrates the applied set-point during optimisation,

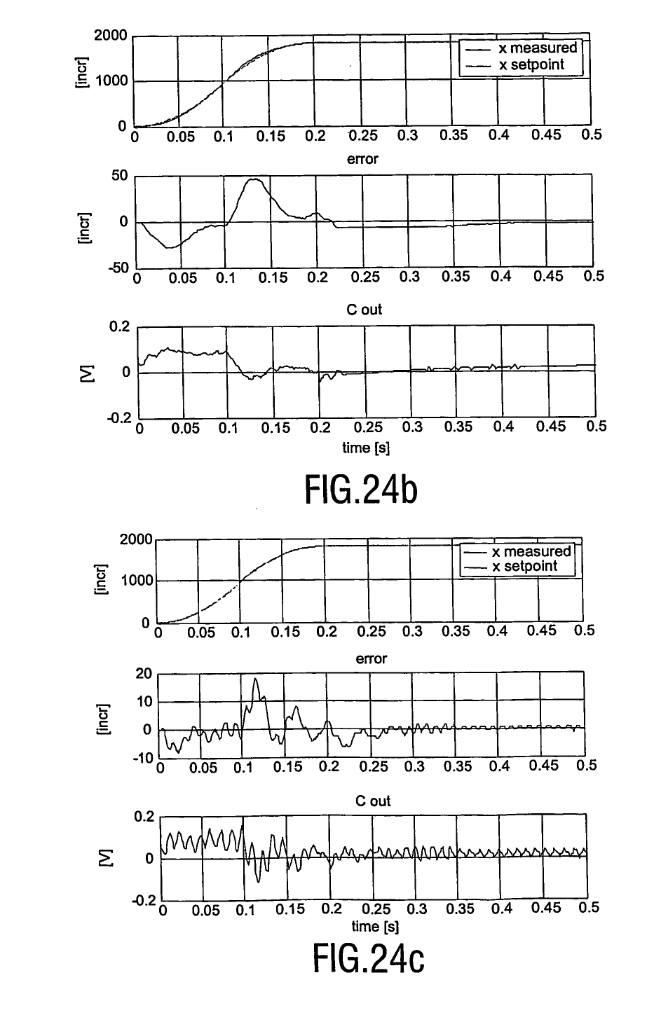

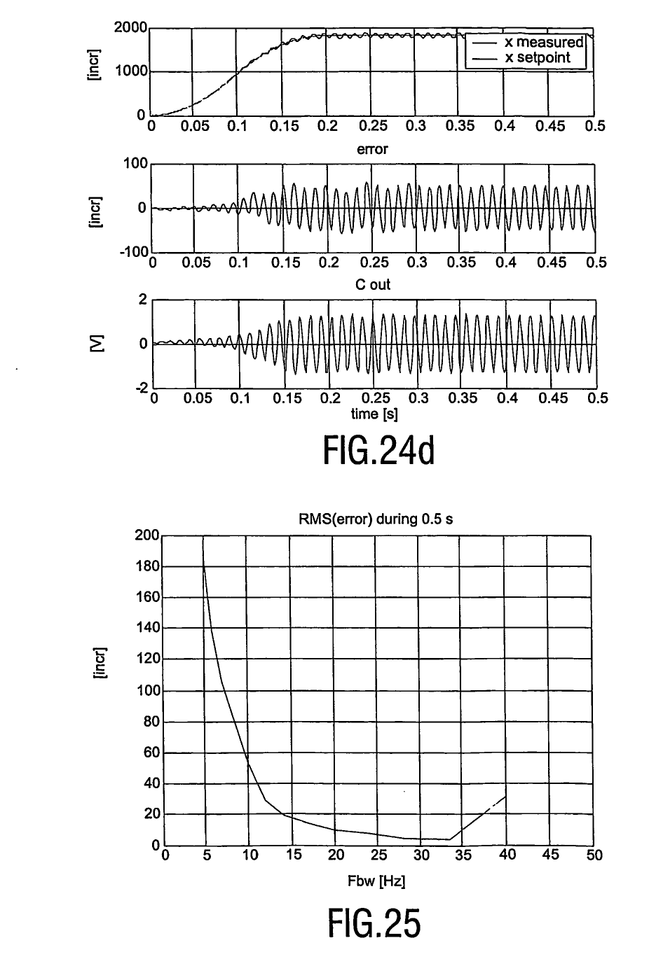

FIG. 24 shows measured position, error and controller output for four different bandwidth frequencies and

FIG. 25 shows the RMS-criterion as a function of the applied bandwidth frequency.

FIG. 1 shows an embodiment of a device for identification of the system parameters of an electro-mechanical servo system. Shown are control means 1 for controlling the application of a force to the electro-mechanical system 3, an actuator 2 for converting the electrical control output signal into a mechanical force to be applied on the mass of the electro-mechanical system 3, sensor means 4 for measuring the movement of the mass and processing means 5 for processing the measured movement and for estimating the desired system parameters mass, friction and damping. As explained above the electro-mechanical servo system 3 can be a translating system comprising a mass—shown are two masses m₁, m₂ connected by a spring s—actuated by a force F or a rotating system where a mass (inertia i) is actuated by a torque T.

A particular embodiment of an electro-mechanical servo system under particular assumptions will be discussed in the following, which do, however, not limit the invention.

First, the application range and the user requirements shall be discussed.

The autotuner algorithm according to the present invention has been designed for electro-mechanical systems comprising a lumped mass, possibly with friction and damping, on which a force can be applied. Generally this mass is referred to as a double integrator. The lumped mass approximation is always only valid for a certain frequency range. The main assumption is that the system behaves like a lumped mass in between 1 and 10 Hz. More specifically this means:
No bandwidth limiting resonance below 10 Hz.
No large phase shifts (>20⁰) between 1-10 Hz due to e.g. low-pass or delay characteristics of amplifiers or sensors.
System is not open loop unstable.
   Other Important Assumptions Are:
System behaves linear except for friction, e.g. inhibits limited play and limited non-linear transmissions like cam-shafts etc.
Input for the controller is a position, measured with an incremental encoder system.

For the autotuner algorithm it is assumed that the items below are known to the user:
Translating or rotating systems: All systems of which the position measurement is performed on a rotating part are considered rotating systems. Systems with a motor driving a translating part by some transmission may be rotating if one measures on the motor but are defined translating when the measurement is on the translating load.
Encoder resolution in [incr/revolution] or [incr/m]
Maximum displacement [m] or [revolutions]
Maximum controller output [V]
Sample time [s] (already available in the controller)

Even though some of the above items may be difficult to specify by the user, these inputs are expected to be essential for some autotuner steps as well as for reasons of safety. It may be possible to apply some smart procedures for detecting the encoder resolution or maximum displacement (e.g.: move system manually to maximum position), but yet no attention has been given in this direction.

Further, in the following no attention is given to the initialisation of the system. For example the important questions of how to get the system within the allowable moving range and how to initialise the measurement system are not discussed in the following. It is assumed that when the autotuner algorithm is started the system is in the middle of the allowable moving range.

Next, system parameters and variables and autotuner parameters shall be illustrated.

The system parameters are parameters which are specific for the system to be tuned. These parameters may be specified by the user. In some cases they have default values as shown in the following table.

| Parameter | unit | Default | Comment |
|---|---|---|---|
| U_MAX | [V] | 2.5 | Maximum controller output (user |
| | | | specified) |
| X_MAX | [incr] | — | Maximum displacement/rotation from the |
| | | | middle in + and − direction (user |
| | | | specified) |
| T_SAMPLE | [s] | 1 10⁻³ | Sample time of the controller |

System variables are variables containing measurements and computation results as shown in the following table.

| Parameter | Unit | Comment |
|---|---|---|
| x | [incr] | Position/rotation measurement |
| c_out | [V] | Controller output |
| T | [s] | (Discrete) time |
| u_break-away | [V] | Controller output voltage at which a movement of |
| | | BREAK-AWAY_LEVEL [incr] is detected |
| polarity | [−] | Sign(c_out)/sign(x) |
| a_block | [V] | Amplitude of the block-wave excitation |
| a_block_linear | [V] | Block-wave amplitude at which a linear movement was expected |
| vᵢ | [incr/s] | Average velocity between ⁱ⁻¹/_{8*BLOCK}_{_{—}}_{FREQUENCY} and |
| | | ⁱ/_{8*BLOCK}_{_{—}}_{FREQUENCY}, for i = 1, 2, 3, 4 |
| x_linear | [incr] | Maximum displacement when applying a_block_linear |
| a_block1 | [V] | Block-wave amplitude for first linear movement |
| a_block2 | [V] | Block-wave amplitude for second linear movement |
| Kfc_safety | [V] | First friction estimate, used for computing x_expected2 |
| kdc_safety | [incr/Vs²] | First k_dc estimate, used for computing x_expected2 |
| x_expected2 | [incr] | Expected displacement when applying a_block2 |
| k_dc | [incr/Vs²] | mass feedforward gain |
| k_fv | [Vs/incr] | damping feedforward gain |
| k_fc | [V] | Friction feedforward gain |
| k_fa | [Vs²/incr] | mass feedforward gain |
| f_bw | [Hz] | Bandwidth frequency (0 dB crossing of the open loop) |
| f_i | [Hz] | Breakpoint frequency integrator ( Ki/2π) |
| f_lp | [Hz] | Low-pass filter corner frequency |
| k_p | [−] | Gain of proportional part of controller |
| k_v | [−] | Gain of derivative part of controller |
| a_setpoint | [incr/s²] | Acceleration setpoint during optimisation |
| v_setpoint | [incr/s] | Maximum velocity setpoint during optimisation |
| x_setpoint | [incr] | Maximum displacement during optimisation |
| setpoint_optim | [−] | Object containing the setpoint to be used during |
| | | optimisation |

The autotuner parameters are parameters which characterise some actions of the autotuner. All these parameters and default values are motivated below:

| parameter | unit | Default | Comment |
|---|---|---|---|
| RAMP_SLOPE | [V/s] | 0.2 | Slope of ramp function |
| BREAK- | [incr] | 100 | Movement level at which it is expected that |
| AWAYLEVEL | | | the controller output exceeds the stick-slip |
| | | | level |
| A_BREAK- | — | 0.9 | Safety factor for break-away level |
| AWAY_SAFETY | | | computation |
| BLOCK_FREQUENCY | [Hz] | 2 | Frequency block-wave |
| X_MIN_BLOCK_T | [m] | 0.5 l0⁻³ | Displacement level below which the |
| | | | movement is considered non-linear, |
| | | | translating system |
| X_MIN_BLOCK_R | [rev] | 0.17 | Rotation level below which the movement |
| | | | is considered non-linear, rotating system |
| V_MIN_BLOCK | [incr/s] | ^{1 incr.}/_{T}_{_{—}}_{SAMPLE} | Velocity level below which the movement |
| | | | is considered non-linear |
| SETTLE_TIME_{—} | [s] | 0.3 | Waiting time for the system to settle after |
| BLOCK | | | applying a one period block-wave |
| DELTA_BLOCK | [V] | 0.1 | Voltage with which the block-wave |
| | | | amplitude is increased when the movement |
| | | | was considered non linear. |
| A_BLOCK_FACTOR1 | — | 1.25 | Factor by which a_block_linear is increased |
| | | | for the first linear movement |
| A_BLOCK_FACTOR2 | — | 1.5 | Factor by which a_block_linear is increased |
| | | | for the second linear movement |
| A_EXPECTED_{—} | — | 0.5 | Safety factor for computing expected |
| SAFETY | | | displacement when applying |
| | | | A_BLOCK_FACTOR2 |
| INITIALBAND- | [Hz] | 5 | Initial bandwidth frequency |
| WIDTH | | | |
| PHI_PM | [⁰] | 45 | Required phase margin (phase of the open |
| | | | loop at f_{bw}) |
| BETA_LP | [−] | 0.65 | Relative damping of the low-pass filter |
| INTEGRATORRATIO | [−] | 0.31 | Ratio between f_{bw} and f_{I} |
| LOWPASSRATIO | [−] | 30 | Ratio between fₗₚ and f_{bw} |
| T_SETPOINT_{—} | [s] | 0.2 | Setpoint duration during optimisation |
| OPTIM | | | |
| SETTLE_TIME_{—} | [s] | 0.3 | Waiting time after applying a setpoint for |
| OPTIM | | | optimisation. |
| BW_INCREASE_{—} | [−] | 1.19 | Factor with which the bandwidth is |
| FACTOR | | | increased during one optimisation step |

The method for identification of the system parameters shall be explained in the following with reference to the flow chart of FIG. 2. All steps of the method will be illustrated further by simulated or experimental measurements shown in a number of further figures.

First, ramp excitation of step S1 shall be explained.

The main goal of the first step S1 is to obtain a starting voltage for the block-wave analysis. By applying a slowly increasing voltage and by tracing the position measurement the break-away voltage can be detected. The break-away voltage is a measure for stick-slip which, for dry-lubricated systems, will be close to the friction. For systems with a lot of play or virtual play the estimate may be poor.

The two important autotuner parameters to be set are the slope of the ramp function and the break-away detection level, i.e. the displacement at which the system is expected to have exceeded the stick-slip level.

The break-away level detection has to detect the stick-slip level. This may be hard as is shown in FIG. 3 and FIG. 4, which show the results after applying two different ramp functions to the system. Before reaching the actual stick-slip level (of 0.48 V is this example) a displacement of over 10 incr. is detected. This is easily observed in FIG. 3. Due to effects like play the actual system starts moving before reaching the actual stick-slip level. The break-away detection level should be large enough to be able to deal with some play. On the other hand: if the break-away level detection is chosen too large an over-estimation of the break-away voltage may be obtained and this may result in a dangerous (too large) starting voltage of the block-wave analysis.

In a particular practical embodiment a break-away level detection of 100 incr. was found to be efficient. As it is hard to obtain better information on theoretical grounds a break-away detection level of 100 incr. is proposed as an example.

The importance of the slope of the ramp can also be explained with reference to FIG. 3 and FIG. 4. When applying a relatively steep slope (FIG. 3) the displacement increases relatively slow. Then it is hard to estimate stick-slip. A break-away level of 20 increments or 100 increment gives completely different results. So the break-away voltage then depends merely on the break-away detection level.

FIG. 4 presents the results after applying a ramp with as small slope: the measured displacement increases very rapidly after exceeding the stick-slip level. Now the computed break-away voltage will be less sensitive for the break-away-level. An obvious disadvantage of a small slope is the large duration of the first step of the autotuning algorithm. As an example a slope of 0.2 V/s is proposed.

After applying the ramp function the system brakes on friction or damping (if present).

Damping and friction levels are unknown at this point, so for safety the controller has to make sure the system brakes. This can be performed by reversing the controller output immediately after exceeding the break-away-level, and to hold this output until the velocity equals zero.

Most systems will have some direction dependency in the stick-slip level and thus also in the break-away voltage. It is expected that the direction dependency is small and that an estimator for one direction is also a sufficient accurate estimator for the opposite direction.

As a movement is performed the polarity can be set. With the assumption that the initial polarity in the controller is set to 1 the polarity can be computed by:
POLARITY=SIGN(Cᵤₜ)*SIGN(X).

The proposed algorithm has been applied to a 4^{th} order experimental set-up.

The results are shown in FIG. 5. The experimental set-up is self-braking due to friction and stops almost immediately after reversing the sign of the controller output. It should be noted that the position measurement does not shoot away like in FIG. 4 even though both results presented in FIG. 4 and FIG. 5 are measured on the same set-up. Apparently the non-linear behaviour at voltage levels close to friction is not very repeatable.

Thus, as a result of the ramp excitation (S1) a first estimate of the fiction and direction of movement is obtained (S2) which are used in the following block-wave excitation (S3) to be explained next.

For the autotuner algorithm it is assumed that the system to be tuned can be modelled as a mass-friction-damper system comprising a mass m₂ and a damper b as shown in FIG. 6. It was found that a friction-mass model having no damper was not sufficient to obtain the desired accuracy.

The model can be described with the differential equations:
F+F_{f}=m\ddot{x}+b\dot{x} (Equation 1)
Assuming a constant force F is applied, solving the velocity with the assumption that x(0)=x₀ and x(0)=v₀ gives the relation:

$$\dot{x} ( t ) = \frac{F + {F}_{f}}{m} t - \frac{b}{m} ( x ( t ) - {x}_{0} ) + {v}_{0} . \qquad ( Equation 2 )$$

Now also x can be solved, with x(0)=x₀ the relation can be written as:

$$x ( t ) = \frac{m ( F + {F}_{f} )}{{b}^{2}} ( {ⅇ}^{\frac{b}{m} t} - 1 + \frac{b}{m} t ) + \frac{{mv}_{0}}{b} ( 1 - {ⅇ}^{\frac{b}{m} t} ) + {x}_{0} . \qquad ( Equation 3 )$$

If damping tends to zero

$$( {ⅇ}^{\frac{b}{m} t} \approx 1 - \frac{b}{m} t + \frac{1}{2} {( \frac{b}{m} )}^{2} {t}^{2} )$$

and v₀=0 and x₀=0 the relation simplifies to:

$${lim}_{b -> 0} x ( t ) = \frac{F + {F}_{f}}{2 m} {t}^{2} .$$

If x is measured at three time points after applying a constant force up to T₁ (and known initial conditions) b/m can be solved. The three time points are chosen as respectively T_{B}, 2T_{B}, 4T_{B} with T_{B}=¼T₁=¼ ½T_{block} (a fourth of one half period of the block-wave)

$$2 π {\hat{f}}_{bd} = \frac{b}{m} = \frac{ln ( \frac{1}{B - 1} )}{{T}_{B}} \qquad ( Equation 4 )$$

with

$$B = \sqrt{\frac{x ( 4 {T}_{B} ) - 2 x ( 2 {T}_{B} ) + x ( 0 )}{x ( 2 {T}_{B} ) - 2 x ( {T}_{B} ) + x ( 0 )}}$$

and f_{bd} the damping breakpoint frequency (frequency below which damping dominates the system). After solving b/m it is possible to estimate K_{dc} (estimator for 1/m if another movement with a different block-wave amplitude is performed:

$${\hat{K}}_{D C} = \frac{( {x}_{2} ( {T}_{1} ) - {x}_{1} ( {T}_{1} ) ) {( \frac{b}{m} )}^{2}}{( {ⅇ}^{\frac{b}{m} {T}_{1}} - 1 + \frac{b}{m} {T}_{1} ) ( {A}_{block2} - {A}_{block1} )} . \qquad ( Equation 5 )$$

The above equation can also be used for two movements with identical initial velocities. When the damping tends to zero the above formula simplifies to:

$${lim}_{b -> 0} {\hat{K}}_{D C} = 2 \frac{{x}_{2} ( {T}_{1} ) - {x}_{1} ( {T}_{1} )}{( {A}_{block1} - {A}_{block1} ) {T}_{1}^{2}} .$$

Now also an estimate of the damping can be obtained (using equation 4):

$$\hat{b} = \frac{ln ( \frac{1}{B - 1} )}{{T}_{B} {\hat{K}}_{d c}} . \qquad ( Equation 6 )$$

With the estimate of K_{dc} and the measured displacement during applying A_{block2} it is possible to estimate coulomb friction (K_{fc})

$${\hat{K}}_{fc} = \frac{{( \frac{b}{m} )}^{2} {x}_{2} ( {T}_{1} )}{{\hat{K}}_{d c} ( {ⅇ}^{\frac{b}{m} {T}_{1}} - 1 + \frac{b}{m} {T}_{1} )} - {A}_{block2} . \qquad ( Equation 7 )$$

With help of Equation 5 it can be shown that the friction estimator can be written such that it is completely independent of the damping and mass estimates. It should be noted that when using the above equations 5 and 7 the movements as a result of A_{block1} and A_{block2} should be in the same direction. So, if the direction dependency of friction is also preferred to be computed 4 movements are required (A_{block1}, A_{block2} and −A_{block1}, −A_{block2}). Equation 7 can also be used when K_{dc} has been computed in a certain direction (two movements required) and the friction is computed for the opposite direction (at cost of error propagation of the K_{dc} and b/m estimate). Then three movements are required for computing friction in two directions (A_{block1}, A_{block2} and −A_{block2}).

For reasons of accuracy in the K_{fc} estimate in both directions it is proposed to perform 4 movements (A_{block1}, A_{block2} and −A_{block1}, −A_{block2}) with the autotuner.

For the analysis two responses are needed in one direction resulting from a constant force (S3). As also a braking mechanism has to be applied (S4) since the system is in open loop the most convenient wave form is a block-wave.

For applying a block-wave two parameters have to be set carefully:
1) Block-wave frequency
2) Block-wave amplitude

The frequency of the block has to be that small that the system behaves in a (quasi) static way. Mostly, system dynamics can be represented by a fourth order system comprising two masses m₁ and m₂ connected by a spring and a damper as shown in FIG. 7.

The first resonance of systems for which the autotuner is used is assumed to be above 10 Hz. After applying a step on the force it depends on the level of vibrations relative to the absolute displacement (x₁ or x₂) for how long the dynamics significantly influences the position measurement. It can be shown that the maximum error (defined as position difference between motor and load position) equals eₘₗ=F/k,. Assuming that m₁=m₂ the amplitude of the motor vibration is: e=½F/k, with F the input force and k the transmission stiffness. The position (x) of the motor can be approximated with:

$$x = \frac{1}{2} \frac{F}{{m}_{1} + {m}_{2}} {t}^{2}$$

using the assumption that the worst case resonance frequency equals

$$10 Hz ( = \frac{1}{2 π} \sqrt{\frac{k}{{m}_{1} {m}_{2} / {m}_{1} + {m}_{2}}} )$$

and assuming that m₁=m₂ =m the relation can be rewritten as:

$$x = \frac{1}{4} \frac{F}{2 k / {( 2 π10 )}^{2}} {t}^{2} .$$

Now the relative error can be computed:

$$\frac{e}{x} = \frac{1}{100 {π}^{2} {t}^{2}} . \qquad ( Equation 8 )$$

This relation means that for example after 0.25 s the error caused by 4^{th} order dynamics is smaller than 1.6% of the resulting displacement, even when the system is undamped. The formula is illustrated with help of FIG. 8 which shows worst-case errors due to dynamics simulated for a 10 Hz resonance 4^{th} order system with several values for damping, including β=0.

It should be noted that the dynamics may significantly influence the response below 0.1 s. For systems with low-frequent dynamics it may be much better to choose other time points for analysis. For example: choose 4 equidistant time-points between 0.1 s and 0.25 s for analysis. Worst case error in the position due to dynamics is less than 10%. The initial velocity and position can easily be dealt with in the formulas for the estimators.

When the motor mass m₁ is larger than the load mass m₂ the same relation, i.e. equation 8, can be used for a worst case estimate. However, when the mass of the load is larger than the motor mass, influence of dynamics will be worse. Systems are usually designed to have a larger motor mass than load mass.

A second consideration for the duration of the block-wave is that the motor may start resonating in the virtual play. If the duration of the constant force is larger than 0.1 seconds a movement in the virtual play can be distinguished from a movement outside the virtual play. This is explained in the block-wave amplitude section below.

Because of the influence of dynamics and the possibility to check if the movement is outside the virtual play it is proposed to choose the block-wave frequency as 2 Hz.

Now, the block-wave amplitude shall be discussed. It is not possible to establish a sensible block-wave amplitude with the available system knowledge (user input and results from ramp-analysis). For this reason the amplitude of the block-wave is increased in steps until a good movement is measured. A start level for the block-wave amplitude has been derived in the ramp-function analysis (steps S1, S2). For safety it is proposed to choose the initial block-wave amplitude as A_BREAK-AWAY_SAFETY * u_break-away. As an example it is proposed to choose A_BREAK-AWAY_SAFETY as 0.9.

For detecting a good movement two items are important: all parts are moving (not just the motor), and the system behaves linear.

A motion of all parts shall now be achieved. A complex system is a motor controlled system which drives by some transmission a load which is subjected to more friction than the motor, as depicted in FIG. 9 showing a motor controlled fourth order system with friction on the load. Because of virtual play the system may start moving/resonating in the stiffness of the play (with a frequency which may be smaller than 10 Hz as the resonating mass is larger when the load is in standstill: for m₁=m₂ the new resonance frequency becomes 10/\sqrt{2} Hz). This behaviour is shown in FIG. 10 showing a typical simulated response of the motor of a fourth order system with friction on the load, m₁=m₂ and a 10 Hz resonance, on which one period of a 2 Hz block-wave is applied. FIG. 10a shows an undamped system and FIG. 10b shows a system with a relative damping of β=0.95.

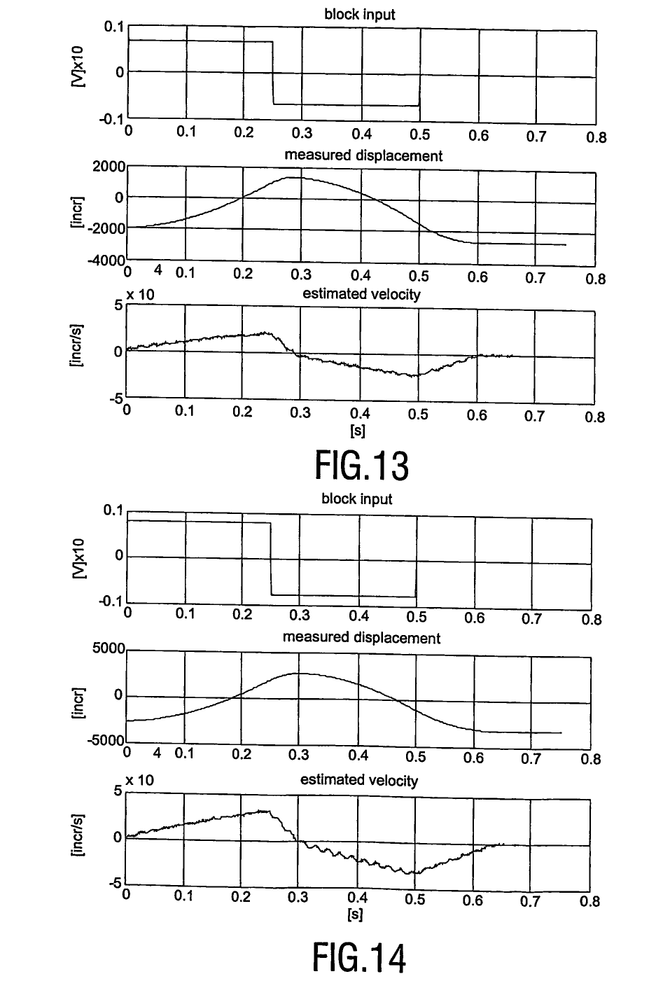

FIG. 10 shows the simulation results of applying a block-wave with an amplitude just below the friction level to a fourth order system like depicted in FIG. 9. This resonating movement in the virtual play can be distinguished from a movement of the complete system by considering the displacement or velocity signal carefully. For a free moving mass the velocity increases (e.g. refer to FIG. 13) whilst for a movement in the virtual play the velocity crosses zero within the 0.25 duration of the constant force. This behaviour also imposes a limit on the block-wave frequency as for a 0.1 duration of the constant force it will be very hard to distinguish the movement in the play from a free mass movement (refer to FIG. 10).

A reliable check if the movement is in the virtual play or outside the virtual play is possible on the velocity signal: if the movement is outside the virtual play the velocity increases in time (proportional with the time if damping is absent). The proposed check is to divide the constant force interval (½T_{block}=0.25 [s]) in four equidistant sections and to compute the average velocity for these intervals. The section are defined by 0−T_{B}−2T_{B}−3T_{B}−4T_{B} with T_{B}=¼ 1/2T_{block}=0.0625 S. Then the following check (S5) must be performed:
V₄>V₃>V₂>V₁>0
or

$$\frac{x ( 4 {T}_{B} ) - x ( 3 {T}_{B} )}{{T}_{B}} > \frac{x ( 3 {T}_{B} ) - x ( 2 {T}_{B} )}{{T}_{B}} > \frac{x ( 2 {T}_{B} ) - x ( 1 {T}_{B} )}{{T}_{B}} > \frac{x ( {T}_{B} ) - x ( 0 )}{{T}_{B}} > 0.$$

Besides virtual play, actual play may exist in the system. If the system moves in the play the movement is like a free moving mass. This can not be distinguished from a movement outside the play. So this is very hard to deal with, and it can only be assumed that the actual play is small.

Now, linearity shall be discussed. Effects like cogging or play may have significant influence for small movements and as a consequence the estimators may be poor. Cogging depends on the number of magnets/coils in a motor which for rotating motors typically varies between 6 and 12. The velocity check of step S5 may not be sufficient for detecting these non-linear effects. Adding a check on minimal displacement may prevent mistakes. For rotating systems a minimal displacement of ⅙ rotation and for translating systems 0.5 mm will in most cases guarantee that the influence of cogging and play is small. Care must be taken that 0.5 mm or ⅙ rotation is not close to the maximum displacement (close means 10% of the maximum displacement); in that case a minimal displacement of 1/10 of the maximum displacement is preferred.

When the velocity check (S5) or the minimal displacement check have not been passed the amplitude of the block-wave must be increased (S6). The new amplitude must be that small that the system remains within its limits, so a small raising of the amplitude improves safety. However, when the steps are too small the block-wave analysis may consume quite some time. As an example, a step size of 0.1 V is proposed.

When the checks (S5) have been passed for the first time a linear movement has been obtained. The corresponding block-wave amplitude (defined as Aₗᵢₙₑₐᵣ) is mostly just above the friction level. It was found in experiments that this first linear movement did not result in the best estimators; however, a preliminary estimate for mass and friction can be found (S7).

Therefore, it is proposed to increase the block-wave amplitude in step S8 and to perform further block-wave excitations (S10) including a stop of the mass (S11). It is expected generally that increasing the amplitude with 25% and 50% (at least two movements are required for analysis; a counter is applied in step S13) suffices:
A_{block1}=1.25 Aₗᵢₙₑₐᵣ and A_{block2}=1.5 Aₗᵢₙₑₐᵣ.

Numerous variations are possible for computing A_{block1} and A_{block2}. The best way is to verify the settings on several set-ups. Usually it is expected that it is possible to apply a force of 1.5 times the friction force without exceeding maximum displacement levels.

Care must be taken that the system boundaries (maximum displacement and Uₘₐₓ) are not exceeded (S9). After applying Aₗᵢₙₑₐᵣ it is possible to predict displacements. When assuming zero damping an initial estimate K_{dci} of K_{dci} can be obtained by:

$${\hat{K}}_{DCi} = \frac{1}{2} \frac{x ( {T}_{1} ) - x ( {t}_{0} )}{( {A}_{linear} - {\hat{K}}_{FCi} ) {T}_{1}^{2}} ,$$

with T₁ half a period of the block-wave (0.25 s for the proposed 2 Hz block-wave) and with

$${\hat{K}}_{FCi} = {A}_{linear} \frac{2 {T}_{1} - {T}_{v = 0}}{{T}_{1}} ,$$

in which Tᵥ₌₀ is the time-point were the direction of movement changes. K_{dc} is in the presence of damping an overestimation.

Now it can be checked (S9) if the expected displacement is smaller than 50% of the maximal displacement. The 50% is a safety margin: the system starts braking at T₁ but it may take up to time 2T₁ before the system actually stops. The total displacement is then maximal 2 x(T₁).

$${x}_{expected1} ( {T}_{1} ) = \frac{1}{2} ( {A}_{block1} - {\hat{K}}_{fc} ) {\hat{K}}_{dc} {T}_{1}^{2} < \frac{1}{2} {x}_{max}$$

$${x}_{expected2} ( {T}_{1} ) = \frac{1}{2} ( {A}_{block2} - {\hat{K}}_{fc} ) {\hat{K}}_{dc} {T}_{1}^{2} < \frac{1}{2} {x}_{max}$$

If the above inequities apply, the new block-waves with A_{block1} and A_{block2} can be applied. If not, other block-wave amplitudes have to be chosen (S12). Another constraint to be dealt with is the maximum controller output.

The following dealing with constraints is proposed:

Block-Wave Amplitude Constraints:

If A_{block2} is larger than Uₘₐₓ it is proposed to choose A_{block2}=Uₘₐₓ and A_{block1}={Aₗᵢₙₑₐᵣ+A_{block2}}/2
   Displacement Constraints:
if x_{expected2} is larger than xₘₐₓ it is proposed to choose

$${A}_{block2} = \frac{{x}_{max}}{{\hat{K}}_{dc} {T}_{1}^{2}} + {\hat{K}}_{fc} = \frac{{( 2 {f}_{block} )}^{2} {x}_{max}}{{\hat{K}}_{dc}} + {\hat{K}}_{fc}$$

(then x_{expected2} equals xₘₐₓ) and A_{block1}={Aₗᵢₙₑₐᵣ+A_{block2}}/2.

The amplitude variation between A_{block1} and A_{block2} should be large enough to ensure a good resolution. For systems with little friction it may be wiser to choose A_{block1} and A_{block2} for example as respectively Aₗᵢₙₑₐᵣ+0.1Uₘₐₓ and Aₗᵢₙₑₐᵣ+0.2Uₘₐₓ, instead of a certain percentage of Aₗᵢₙₑₐᵣ (approximately equal to friction).

Finally (S14), good estimates for friction, mass and damping are obtained by equations 5-7 above.

The above has been verified in an experimental set-up. First, a one-period block-wave with an amplitude of 90% of U_{break-away} is applied. U_{break-away} was established at 0.48 V, which is just above the friction level of 0.46 V. The results of the first block-wave are shown graphically in FIG. 11.

For judging linearity the (average) velocity for 4 equidistant intervals between 0 and 0.25 s (constant force part) is computed. The velocities computed are respectively: v₁=1475, v₂=903, v₃=419 and v₄=1226 [incr/s]. As this is not an increasing sequence the movement is considered not linear (or in the virtual play) and the block-wave amplitude is raised with 0.1 V (S6) and applied again (S3). The new results are shown in FIG. 12.

Again the (average) velocity is computed for 4 equidistant intervals between 0 and 0.25 s: v₁=2459, v₂=5419, v₃=7113 and v₄=7903 [incr/s]. An equivalent check would be to check if the displacement is monotonously increasing. Now the movement is judged to be linear, so Aₗᵢₙₑₐᵣ=0.532. Now an initial K_{fc} and K_{dc} is estimated (S7; for reasons of safety only):
\hat{K}_{fc}=0.45 [V](computed with T₁=0.25 s and Tᵥ₌₀=0.271 s).
\hat{K}_{dc}=5.6 10⁶[incr/Vs^{2]}

Both estimates are reasonably accurate (actual values (0.48 and 4.8 10⁶). It should be noted that K_{dc} is overestimated, which is typical for this estimation method.

Now it is checked whether it is possible to raise A_{block} with another 50% (S8, S9).

$${A}_{block2} = 1.5 {A}_{linear}$$

$${x}_{expected} = \frac{1}{2} ( {A}_{block2} - {\hat{K}}_{fc} ) {\hat{K}}_{dc} {T}_{1}^{2} = {610}^{3} [ incr ] .$$

As x_{expected} is smaller than 50% of the maximum displacement it is expected to be possible to raise the amplitude with 25% (A_{block1}) and 50% (A_{block2}). First the block-wave with amplitude A_{block1}=1.25 A_{blocklinear} is applied. The results are shown in FIG. 13. The maximum displacement (relative to the initial position) was measured to be 3.3 10³ [incr].

Next, the block-wave with amplitude A_{block2} is applied, the results are shown in FIG. 14. The maximum displacement (relative to the initial position) was measured to be 5.3 10³ [incr](x_{expected}=6 10³ proved to be a good safety estimate)

Now all data needed for processing in one direction is acquired. The successive movements have been shown in FIGS. 11-14. It should be noted that the position remains close to zero, even after 4 block-waves in one direction.

The same experiments have also been performed in the opposite direction.

The estimators, resulting from the equations presented above, are presented in the tables below:

b/m estimation

| | | |
|---|---|---|
| Positive direction | T_{b} = 0.062 [s] | \hat{f}_{bd} = 0.55 Hz |
| | x(4T_{b}) = 4669 [incr] | ( b/m = \hat{f}_{bd} · 2π) |
| | x(2T_{b}) = 1338 [incr] | |
| | x(T_{b}) = 362 [incr] | |
| Negative direction | T_{b} = 0.062 [s] | |
| | x(4T_{b}) = −3538 [incr] | \hat{f}_{bd} = 0.41 Hz |
| | x(2T_{b}) = −992 [incr] | |
| | x(T_{b}) = −269 [incr] | |

After averaging: \hat{f}_{bd} = 0.48 Hz

K_{dc} estimation

| | | |
|---|---|---|
| Positive direction | x₁(T₁) = 3047 | K_{fc} = 5.12 10⁶ [incr/Vs²] |
| | x₂(T₁) = 4669 | |
| | A_{block1} = 0.665 | |
| | A_{block2} = 0.798 | |
| Negative direction | x₁(T₁) = −2206 | K_{fc} = 4.83 10⁶ [incr/Vs²] |
| | x₂(T₁) = −3538 | |
| | A_{block1} = −0.540 | |
| | A_{block2} = −0.648 | |

After averaging: K_{dc} = 4.97 10⁶

K_{fc} estimation

| | | |
|---|---|---|
| Positive direction | x₁(T₁) = 3047 | K_{fc} = 0.412 [V] |
| | x₂(T₁) = 4669 | |
| | A_{block1} = 0.665 | |
| | A_{block2} = 0.798 | |
| Negative direction | x₁(T₁) = −2206 | K_{fc} = −0.37l [V] |
| | x₂(T₁) = −3538 | |
| | A_{block1} = −0.540 | |
| | A_{block2} = −0.648 | |

With the estimated K_{dc} also an estimate for the absolute damping can be computed (equation 6): The results for the positive and negative direction are respectively: \hat{b}=6.8 10⁻⁷ and \hat{b}=5.3 10⁻⁷

The results are very accurate, especially the most important estimator K_{dc} estimate is very good. It was analysed how estimators are influenced by block-wave amplitudes and if estimator errors in b/m propagate in the other estimators. It appeared that estimator errors in b/m hardly propagate.

Next, controller tuning shall be explained. FIG. 15 shows a block diagram of a control loop including a controller 6 according to the present invention. The controller 6 comprises an autotuner 61 for determining the control parameters of the controller based on the parameters of the electro-mechanical system 3 estimated as described above. Therefore, the autotuner 61 preferably comprises control means and processing means as shown in FIG. 1 for estimating said system parameters. However, said control means and processing means may also be provided outside the autotuner 61 or outside the controller 6. The controller 6 further comprises a trajectory generator 62 for generating a trajectory to be fed to a feedback control unit 63 and feedforward control unit 64. Further a signal generator 65 is provided for generating test signals. The elements 62 to 65 are controlled by the autotuner, and their outputs are switched on a common output by a switch 66 connected to the actuator 2. It should be noted that elements 62 and 65 could also be external devices.

The most important feedback controller objective is to stabilise the system. In the autotuner this is realised by providing a phase lead at the bandwidth frequency. For controller tuning the Kₚ and Kᵥ part are used for providing the necessary amplification as well as for providing the phase lead. The phase lead has to be chosen large as it can not be excluded that there is phase loss in the system at the bandwidth frequency (e.g. phase lag in amplifier etc.)

It is also possible, and in some cases desirable, to tune a 2^{nd} order low-pass filter and an integrator provided in the controller. The 2^{nd} order low-pass filter reduces the high frequent amplification which usually results in a smoother (less noisy) controller output. As a consequence the controller tuning seems more reliable to the user. Disadvantage is that it gives additional phase lag at the bandwidth frequency. This can be compensated for by increasing Kᵥ, but this results in less amplification at low frequencies (for a certain bandwidth and phase margin). The integrator may be used for 1) improving setpoint tracking by increased low-frequent gain, 2) improve settling by realising a zero-error in the presence of friction 3) increasing the settling speed by activating the integrator at the end of the setpoint. Disadvantage is that it also results in a phase lag at the bandwidth frequency (which also can be compensated by Kᵥ).

The term “bandwidth” shall be understood as the (most low-frequent, descending) 0 dB crossing of the open loop frequency response function of x/Cᵢₙ wherein x is the output (position or rotation measurement) of the system and Cᵢₙ is the controller input signal.

The controller (consisting of Kₚ, Kᵥ, integrator and low-pass filter) can be approximated (continuous description) with the relation

$${H}_{c} = ( {K}_{p} + {K}_{v} s ) ( 1 + \frac{{K}_{i}}{s} ) ( \frac{{( 2 π {f}_{lp} )}^{2}}{{s}^{2} + 2 {β}_{lp} 2 π {f}_{lp} s + {( 2 π {f}_{lp} )}^{2}} )$$

with Kₚ the proportional gain, Kᵥ the derivative gain, Kᵢ the integrator gain, fₗₚ the 2^{nd} order low pass filter frequency and βₗₚ the damping of the low pass filter. The controller has breakpoints at the frequencies: fᵢ=Kᵢ/(2π), f_{d}=Kₚ/(Kᵥ2π) and fₗₚ.

With the controller a certain phase margin and a certain amplification at the bandwidth frequency shall be established. For computing the Kₚ and Kᵥ formulas are derived below. It is assumed that first the low-pass filter and optionally the integrator have been set (rules of thumb for the settings will be discussed later) and then to compute Kₚ and Kᵥ to establish the desired phase margin and amplification.

Due to the integrator a phase loss at the bandwidth frequency of

$${φ}_{i} ( {f}_{bw} ) = arctan ( \frac{{K}_{i}}{2 π {f}_{bw}} )$$

is obtained. The low pass filter results in an additional phase loss of

$${φ}_{lp} ( {f}_{bw} ) = arctan ( \frac{- 2 {β}_{lp} 2 π {f}_{lp} 2 π {f}_{bw}}{{( 2 π {f}_{bw} )}^{2} - {( 2 π {f}_{lp} )}^{2}} ) .$$

Also the phase loss due to calculation delay can be computed
φ_{c}(f_{bw})=f_{bw}T_{c}360[⁸]
(so for a calculation delay of 0.1 ms this results in a phase loss of 0.18° at 5 Hz).

From the system

$$( {H}_{system} = \frac{{K}_{dc}}{{s}^{2} + 2 π {f}_{fd} s} )$$

a damping estimate is obtained. The phase provided by damping at the bandwidth frequency equals

$${φ}_{system} ( {f}_{bw} ) = arctan ( \frac{\hat{b} {K}_{dc}}{2 π {f}_{bw}} ) = arctan ( \frac{{f}_{bd}}{{f}_{bw}} ) .$$

The phase lead to be given by the Kₚ−Kᵥ filter now equals
φₖᵥ(f_{bw})=φₚₘ+φₗₚ(f_{bw})+φᵢ(f_{bw})+φ_{c}(f_{bw})−φ_{system}(f_{bw})
with φₚₘ the desired phase margin.

The Kₚ−Kᵥ part of the controller provides a phase lead of

$${φ}_{kv} = arctan ( \frac{{K}_{v} 2 π {f}_{bw}}{{K}_{p}} ) .$$

(Equation 9)

It should be noted that a maximum phase lead of 90° can be achieved by the Kₚ−Kᵥ controller part. The KₚKᵥ part also has to realise a amplification such that the open loop gain equals one at the bandwidth frequency.

The amplitude of the open loop at the bandwidth frequency can be computed from
|Hₒₗ(f_{bw})|=1=\sqrt{Kₚ²+(Kᵥ2πf_{bw})²}K_{system}(f_{bw})Kₗₚ(f_{bw})K_{integrator}(f_{bw}) (Equation 10)
with:

$${K}_{system} = \frac{{\hat{K}}_{dc}}{2 π {f}_{bw} \sqrt{{( 2 π {f}_{bw} )}^{2} + {( 2 π {f}_{d} )}^{2}}} , \\ {K}_{integrator} ( {f}_{bw} ) = \sqrt{1 + {( \frac{{K}_{l}}{2 π {f}_{bw}} )}^{2}} and$$

$${K}_{lp} ( {f}_{bw} ) = \frac{{( 2 π {f}_{lp} )}^{2}}{\sqrt{{( {( 2 π {f}_{bw} )}^{2} + {( 2 π {f}_{lp} )}^{2} )}^{2} + {( 2 {β}_{lp} 2 π {f}_{lp} 2 π {f}_{bw} )}^{2}}} .$$

Using equations 9 and 10 Kₚ and Kᵥ can be solved from the estimated K_{dc}, estimated damping, the desired phase margin and bandwidth frequency.

From equation 9 it follows that:

$${K}_{v} = \frac{tan ( {φ}_{kv} ) {K}_{p}}{2 π {f}_{bw}} . \qquad ( Equation 11 )$$

Substituting in equation 10 Kₚ can be solved:
Kₚ

$${K}_{p} = \frac{cos ( {φ}_{kv} )}{{K}_{system} ( {f}_{bw} ) {K}_{lp} ( {f}_{bw} ) {K}_{integrator} ( {f}_{bw} )} . \qquad ( Equation 12 )$$

Now, with help of equation 11 Kᵥ can be solved as well:

$${K}_{v} = \frac{sin ( {φ}_{kv} )}{2 π {f}_{bw} {K}_{system} ( {f}_{bw} ) {K}_{lp} ( {f}_{bw} ) {K}_{integrator} ( {f}_{bw} )} \qquad ( Equation 13 )$$

So, when an integrator frequency, a low-pass frequency and low-pass damping have been set the Kₚ and Kᵥ can be computed such that the feedback requirements (phase margin and bandwidth) are satisfied. It depends on the user requirements whether or not the integrator is advantageous.

Next, the proposed methods for tuning the controller respectively with and without integrator are explained. For both strategies the tuning aims at a 5 Hz bandwidth system with 45° phase margin

First, controller tuning without integrator shall be discussed.

For the autotuner it is hard to determine an optimal setting for the low-pass filter. When tuning manually, one usually hears (noise) and sees (noisy controller output) whether a low pass filter is required. The low-pas filter can also be used for dealing with dynamics when a frequency response function has been measured. None of the above information is available, so it is best to start with a best guess for the low pass filter. Roughly two ‘best guesses are available’ (although all in between values may be as good or better as well):
1) minimise the high frequent gain with respect to the stability margins,
2) minimise the effect of phase loss due to the low-pass filter and be satisfied with a ‘reasonable’ high frequent amplification.

Both strategies have been simulated. FIG. 16 shows the controller computed with equations 11 and 12 for several low-pass filter settings (fₗₚ=∞fₗₚ=3.8, f_{bw}(I) and fₗₚ=30, f_{bw}(II), for all controllers f_{bw}=5 Hz, phase margin=45° and βₗₚ=70.65). The resulting stability margins are visualised by applying the controller to a double integrator and presenting the Nichols plot in FIG. 17. From FIG. 16 it can be concluded that minimising the low-pass frequency results in a loss of the low-frequent amplification of almost 6 dB. As low-frequent amplification is usually one of the main controller objectives the strategy will not be optimal (unless a strong high frequent reduction is required). It seems more sensible to start with a ‘moderate’ low pass filter frequency of e.g. fₗₚ=30 f_{bw} which hardly reduces the low-pass amplification but still results in a high frequent reduction of 15 dB. The damping of the low-pass filter has been set such that it closely matches the 9 dB−45° M-circle of the Nichols plot (βₗₚ=0.65). After setting the low-pass filter one can measure the noise on the controller output as a measure for undesired high frequent amplification. A measure for noise would be the RMS value of the high frequent (AC) component of the controller output when the system is in standstill. The high frequent component can be obtained by applying a high pass filter to the controller output:

$${A}_{noise} = RMS ( {C}_{out} - \frac{1}{N} {\sum }_{i = N}^{1} {C}_{out} ( i ) ) .$$

It is proposed to choose N as 20 samples as an example.

If Aₙₒᵢₛₑ exceeds a certain value (proposed is 0.5 V) the low-pass filter frequency is decreased to fₗₚ=3.8f_{bw} and the KₚKᵥ settings are computed again and the controller is applied.

An exemplary proposed tuning is:
fₗₚ=30 f_{bw} (decrease only if measure of noise exceeds maximum level)
βₗₚ=0.65

Kₚ and Kᵥ to match the desired gain and phase margin according to equation 12 and equation 13.

Next, controller tuning with integrator shall be discussed.

As mentioned above adding the integrator improves disturbance rejection, tracking and provides a zero error in the presence of friction. It does not necessarily improve settling and it gives a phase lag at the bandwidth frequency which has to be compensated for by increasing the Kᵥ. When an integrator is desired it is usually set to maximal gain without violating the stability margins (phase margin in this case). For an integrator gain which corresponds with an integrator breakpoint frequency of 0.31 f_{bw} the bode diagram is shown in FIG. 18. The Nichols plots are shown in FIG. 19. Again two settings of the low-pass filter have been applied; one ‘moderate’ which aims for maximal low-frequent amplification and one which aims for a minimal high frequent gain without violating the stability margins (fₗₚ=3.8, f_{bw}(I) and fₗₚ=30, f_{bw}(II); for comparison a pure Kₚ−Kᵥ is shown as well; for all controllers f_{bw}=5 Hz, phase margin=45° and βₗₚ=0,65). Aiming for a minimal high frequent amplification results in a loss of low frequent amplification of almost 10 dB (compared to the controller with fₗₚ=30 f_{bw}). This is only recommended when a lot of noise is present. The same criterion as proposed for controller tuning without integrator can be used for setting the low-pass filter.

An exemplary proposed tuning is:
fₗₚ=30 f_{bw} (decrease if measure of noise exceeds maximum level)
βₗₚ=0.65
Kᵢ=0.31 f_{bw}2π(fᵢ=0.31 f_{bw}).

Kₚ and Kᵥ to match the desired gain and phase margin according to equation 12 and equation 13.

With help of the estimates as described above the controller tuning has been computed as proposed above with low-pass filter and integrator and implemented in dSPACE. The measured open loop FRF of the actual system (with the dSPACE controller) and autotuner model (i.e. the mass-damper model and controller formula) are shown in FIGS. 20 and 21. The measured bandwidth was 4.9 Hz and the phase margin was 44° (so very close to the target of 5 Hz and 45°). It can be concluded that the estimated parameters and the proposed controller tuning results in the desired objectives.

Now, an optimisation of the described method shall be explained with reference to the flow chart of FIG. 22. First the system parameters are estimated (S20) and the control parameters are determined by the method of autotuning (S21) as described above. The method of autotuning results in a first bandwidth at which a first movement is performed in step S22. This means that the controller is used to generate a short (e.g. for 0.2 s) trajectory which the system is forced to follow using feedback control and friction feedforward. Depending on the quality of the feedback tuning this results in a small or large error, i.e. a difference between trajectory and measure position.

For performing a bandwidth optimisation it is proposed to increase the bandwidth in steps, i.e. to perform autotuning (S23) to obtain an increased bandwidth. After every step of autotuning (S23) a movement is performed (S24) and the autotuner decides on a criterion whether increasing the bandwidth (or actually the expected bandwidth) was an improvement (S25). Improvement means that the error, i.e. the difference between trajectory and measured position, during and after movement has become smaller. If there was an improvement the algorithm returns back to step S23 to further increase the bandwidth, while in the negative case the best bandwidth is selected (S26) and the algorithm terminates.

Important parameters to be set for this step are:
Step size for increasing the bandwidth
Movement setpoint
Optimisation criterion

For choosing the step size the items below are of importance:
avoid an excessive optimisation time
avoid stability problems: when increasing the bandwidth stability problems may occur.
   The step has to be that small that the risk of becoming unstable in one step is minimal.
resolution has to be acceptable for users.

A double integrator system (−2 slope) implies that when increasing the bandwidth with a factor k the magnitude increases with k². A magnitude raising of 3 dB is usually acceptable (i.e. the system will not become unstable). A magnitude raising of 6 dB (or bandwidth frequency raising of \sqrt{2}) is already risky (starting from a relatively safe amplitude margin of 9 dB the amplitude margin may be reduced to 3 dB in one step, a 3 dB amplitude margin is very close to instability). By performing simulations or more experiments it is possible to check how risky a raising of 6 dB actually is. These checks have not yet been performed and for that it is proposed to remain on the safe side and the increase the controller gain with 3 dB per step. So the bandwidth is increased in steps of {fourth root}\sqrt{2}=1.19. Then in 18 steps a 100 Hz bandwidth system can be achieved starting from a 5 Hz bandwidth system. Whether or not the duration of the optimisation is acceptable depends on the setpoint duration which is discussed below.

The movement setpoint and optimisation criterion are closely linked to each other. The representative movement at least has to deal with the issues:
The movement has to be large and fast enough to ensure that the system behaves linearly
The movement has to be small enough to remain within the limits
Force has to remain smaller than the maximum force

Other movement characteristics depend on the chosen optimisation criterion.

Basically two approaches are possible:
1. Criterion based on settling behaviour. As the focus is on settling, a second order setpoint profile without constant velocity part will do. The most important characteristic is the acceleration duration. If for example the setpoint duration is 0.1 s, the typical frequency contents is at 10 Hz. In that case a 5 Hz bandwidth controller may perform better than a 10 Hz bandwidth controller (due to the peak in the sensitivity curve) and the optimisation will stop in a local minimum. The setpoint should be chosen such that is ‘slower’ than the bandwidth frequency: a good setpoint duration would be 0.2 s. Theory about setpoints in relation to bandwidth frequencies and dynamics is known as input-shaping.
2. Criterion based on tracking. Here, a setpoint with a constant velocity part has to be created. The dynamics may significantly influence the constant velocity during 0.4 s. The dynamics also depend on the bandwidth frequency and the acceleration duration. For certain combinations of bandwidth frequency and acceleration duration the performance will be worse than for a lower bandwidth frequency. So one has to wait until the influence of dynamics is negligible (wait for 0.4 s).

In experiments it was found that using the second approach it is very hard to avoid a local optimum. The second approach also takes more time because of the large constant velocity part. Experimentally good results were found using the first approach with a short setpoint duration in combination with the optimisation criterion as explained below.

Now, feedforward/feedback during optimisation will be explained.

The feedback tuning will be like explained above. All parameters (integrator and low-pass) have to be implemented during optimisation as they influence performance and stability. Less clear is, if it is advantageous to activate the feedforward parameters during optimisation. The friction part of the feedforward is meant to compensate for non-linear behaviour and it ensures that the system starts moving at the beginning of the setpoint. But if, for example, the complete feedforward tuning is perfect and the system behaves like a mass-friction-damper system there will be no difference in the response of a 5 Hz and 10 Hz bandwidth system. For this, the acceleration and damping part of the feedforward should not be activated during optimisation. This theory is also supported by experimental results.

A reasonable value for the setpoint acceleration aₛₚ may be found by choosing the same acceleration as previously used (safely) during the block-wave analysis:
aₛₚ=(A_{block2}−K_{fc})K_{dc}.

The maximum velocity is chosen such that the total setpoint duration equals the desired setpoint duration (proposed: 0.2 s).

$${v}_{sp MAX} = \frac{1}{2} {T}_{setpoint} {a}_{sp} .$$

The setpoint displacement can now also be computed:

$${x}_{sp} = \frac{{v}_{sp}^{2}}{{a}_{sp}} .$$

The setpoint is shown in FIG. 23. Only the magnitude of the setpoint is adjusted to the identified system characteristics, the shape will always be the same. No care has to be taken that the maximum displacement is exceeded as the acceleration magnitude is equal to the acceleration during application of A_{block2}, only now the acceleration time is shorter. So also the maximum controller output will not be exceeded. The duration will be acceptable: one movement takes 0.2 s, another 0.3 s will suffice for settling. So for each step 0.5 s are required, within 18 steps (total time 9 s) a 100 Hz bandwidth can be achieved.

For judging the performance the RMS value of the error during (1) settling or (2) during the setpoint or (3) during both setpoint and settling can be considered It was found that the latter seems most reliable. (1) is not recommended as it is possible that the systems at the end of the setpoint stops on friction (after that is may take quite some time before the integrator manages to overcome friction). Using (2) may result in missing errors after the setpoint. It is proposed to use the combination of both.

For the proposed movement other criteria can be applied as well for judging the performance, such as:

the RMS of the error after the setpoint during 0.3 s;

the RMS of the error during the setpoint only (0.2 s);

the RMS of the error during 0.5 s;

the RMS of the controller output during 0.5 s.

The proposed optimisation is as follows: Apply 2^{nd} order setpoint without constant velocity part with a duration of 0.2 [s] and an acceleration magnitude of A_{block2}−K_{fc}. Compute the RMS value of error during the 0.2 [s] setpoint and 0.3 [s] settling.

In an experimental verification, first the 5 Hz feedback tuning is applied based on the results obtained from the block-wave analysis (see FIG. 20). The applied setpoint is shown in FIG. 23. Next, the movement is performed, first for a bandwidth of 5 Hz, next for a bandwidth of ™\sqrt{25} Hz. After that is it is decided whether the bandwidth raising was an improvement. In case of an improvement the bandwidth is again increased with a factor ™\sqrt{2}. In case of no improvement the optimisation is stopped and the previous controller assumed to optimal and is implemented again. FIG. 24a-d show the response of the system for several bandwidth frequencies (i.e. for 10 Hz, 16.8 Hz, 33.6 Hz and 40 Hz).

The proposed error criterion as a function of the bandwidth frequency is shown in FIG. 25. Up to a bandwidth frequency of 33.6 Hz the criterion is decreasing (i.e. improvement). At 40 Hz the criterion detects a worsening of the performance, and it is decided to apply a bandwidth of 33.6 Hz and to stop the optimisation.

Other optimisation criteria are computed and possible. However, the RMS error has been shown to be the best criterion.

Another movement well worth examining is a movement as a result of a step on the position setpoint. Dealing with friction is the main challenge in this strategy.

Another alternative strategy would be to perform a ‘representative movement’ and ask the user if he wants to increase the bandwidth. After increasing the bandwidth the movement is repeated and the results are shown graphically.

Even with small steps in the bandwidth raising there is still a risk of becoming unstable in one optimisation step (e.g. the presence of badly damped resonances). It is recommended to apply a measure for instability (e.g. controller output), when instability is detected a switch to an old (stable) controller can be made.

From the above the following can be concluded.

The proposed autotuner algorithm performed very well on the experimental set-up. Within several seconds estimates are obtained for damping, friction and the mass. The estimator of the mass and friction were within 10% accurate. The damping estimate was a little bit less accurate, but still within 20% of its actual value. By means of analysis and simulation of dynamics and other common system characteristics like play, virtual play and stick slip it has also been made likely that the autotuner will perform well on other set-ups.

It proved to be important to estimate damping as well. For the experimental set-up estimator errors of over 25% were made if damping was neglected.

The autotuner method is different from other known methods. The main difference is that it was found that analysing the response of a block-wave excitation in open loop leads to more accurate results than could be obtained from a closed-loop sine excitation and closed loop feedforward parameter estimation. Moreover, a block-wave analysis is very efficient. From four movements, which only take 0.5 s each, all important parameters can be estimated.

For the feedback controller, tuning formulas are proposed which compute Kₚ and Kᵥ settings which provide the correct phase lead and amplification, given the mass and damping estimate, integrator frequency and low-pass filter settings. There are no settings which are optimal for all systems. Generally it is recommended to use the low-pass filter only if noise is present on the controller output. A rule of thumb (based on maximum low-frequent gain) is proposed for the integrator setting.

An automatic bandwidth optimisation is proposed. The optimisation performed well on the experimental set-up. Based on the response of the system on a short setpoint profile a criterion judges whether increasing the bandwidth was an improvement. The proposed criterion was selected as it was the only tested criterion which could avoid a local optimum during the optimisation process.

1. Method for identification of the parameters of an electro-mechanical system, in particular an electro-mechanical servo system, comprising a mass actuated by a force, said method comprising the steps of:
a) applying a constant force to said electro-mechanical system for a predetermined time period, said force having an amplitude at a sub-friction level,
b) stopping the mass by applying a negative force,
c) iterating steps a) and b) by increasing the amplitude of the constant force applied in step a) in each iteration until the velocity of said mass is monotonously increasing during application of said constant force,
d) estimating mass and friction of the electro-mechanical system from the measured movement of the mass,
e) performing steps a) and b) at least for another two times by further increasing the amplitude of the constant force applied in step a) wherein the amplitude is increased in each iteration to at most a maximum level at which the electro-mechanical system does not exceed the boundaries of the electro-mechanical system, and
f) estimating mass, friction and damping of the electro-mechanical system from the measured movement of the mass.

2. Method as claimed in claim 1, wherein the friction is estimated based on the ratio between the time required for acceleration and the time required for stopping the mass.

3. Method as claimed in claim 1, wherein mass, friction and damping are estimated based on a mathematical model of the electro-mechanical system.

4. Method as claimed in claim 1, wherein the force is applied as a block-wave signal having a constant maximum amplitude in step a).

5. Method as claimed in claim 1, wherein said predetermined time period is in a range from 0.01 to 5 seconds, in particular 0.25 seconds.

6. Method as claimed in claim 1, further comprising the steps of:
a0) applying a force having a monotonously increasing amplitude until the mass starts moving and
a1) roughly estimating the friction of the electro-mechanical system and determining the direction of movement of the mass from the measured movement of the mass, which steps are performed prior to step a), in which the initial amplitude of the constant force is set lower, in particular 1 to 25% lower, than the friction estimated in step a1).

7. Method as claimed in claim 6, wherein the force is applied as a ramp signal in step a0).

8. Method as claimed in claim 1, wherein the amplitude of the constant force applied in the iterations of step e) is increased by 25% in a first iteration and by 50% in a second iteration.

9. Method as claimed in claim 1, wherein the force is applied as a block-wave signal having a constant maximum amplitude in the iterations of step e), wherein in a first number of iterations, in particular in two first iterations, a force with a positive amplitude and in a second number of iterations, in particular in two subsequent iterations, a force with a negative amplitude, in particular having the same absolute value as said positive amplitude, is applied.

10. Method for autotuning a controller of an electro-mechanical system, in particular an electro-mechanical servo system, comprising a mass actuated by a force, wherein the parameters of said electro-mechanical system are identified by a method as claimed in claim 1, said parameters being used to determine the control parameters of the controller, in particular amplification including its sign, integrator frequency, differentiation frequency and/or low-pass filter settings, such that the electro-mechanical system is operated stable in a low frequency area.

11. Method as claimed in claim 10, wherein said controller comprises a feedback control unit and a feedforward control unit.

12. Method as claimed in claim 10, further comprising a step of optimising the bandwidth of the controller by:
i) performing a predetermined movement at an initial bandwidth,
ii) autotuning the controller to obtain an increased bandwidth,
iii) performing the predetermined movement at the increased bandwidth,
iv) checking whether said bandwidth increase led to an improvement,
v) iterating steps ii) to iv) by increasing the bandwidth and performing the predetermined bandwidth until the step of checking in step iv) shows no further improvement

13. Method as claimed in claim 12, wherein the criterion for checking whether the bandwidth increase led to an improvement is based on a root-mean-square error of the difference between the measured movement and the set-point movement, in particular both during movement and during settling.

14. Method as claimed in claim 12, wherein the first bandwidth is in the range between 1 and 10 Hz, in particular 5 Hz, and wherein the bandwidth is increased in each iteration by a factor in the range between 1 and 2, in particular 2^{0.25}.

15. Method for controlling an electro-mechanical system, in particular an electro-mechanical servo system, comprising a mass actuated by a force, wherein the parameters of said electro-mechanical system are identified by a method as claimed in claim 1, said parameters being used to determine the control parameters of the controller such that the electro-mechanical system is operated stable by a method for autotuning as claimed in claim 10.

16. Device for identification of the parameters of an electro-mechanical system, in particular an electro-mechanical servo system, comprising a mass actuated by a force, comprising:
control means for
a) applying a constant force to said electro-mechanical system for a predetermined time period, said force having an amplitude at a sub-friction level,
b) stopping the mass by applying a negative force, and
c) iterating steps a) and b) by increasing the amplitude of the constant force applied in step a) in each iteration until the velocity of said mass is monotonously increasing during application of said constant force,
sensor means for measuring the movement of the mass, and
processing means for initially estimating mass and friction of the electro-mechanical system from the measured movement of the mass, and for finally estimating mass, friction and damping of the electro-mechanical system from the measured movement of the mass after steps a) and b) have been performed at least for another two times by further increasing the amplitude of the constant force applied in step a) wherein the amplitude is increased in each iteration to at most a maximum level at which the electro-mechanical system does not exceed the boundaries of the electro-mechanical system.

17. Autotuner for autotuning a controller of an electro-mechanical system, in particular an electro-mechanical servo system, comprising a mass actuated by a force, comprising:
a device for identification of the parameters of said electro-mechanical system as claimed in claim 16, and
processing means for determining the control parameters of the controller, in particular amplification including its sign, integrator frequency, differentiator frequency and/or low-pass filter settings, such that the electro-mechanical system is operated stable in a low frequency area.

18. Controller for controlling an electro-mechanical system, in particular an electro-mechanical servo system, comprising a mass actuated by a force, comprising:
an autotuner as claimed in claim 17 for determining the control parameters of the controller, in particular amplification including its sign, integrator frequency, differentiator frequency and/or low-pass filter settings, such that the electro-mechanical system is operated stable in a low frequency, and
control means for controlling the electro-mechanical system.

19. Electro-mechanical system comprising a mass actuated by a force and a controller for controlling the electro-mechanical system as claimed in claim 18.

20. Computer program comprising computer program code for causing a computer to perform the steps of the method as claimed in claim 1, 10 or 15 when said program is run on a computer.
